(19) United States
(12) Patent Application Publication
(10) Pub. No.: US 2018/0229351 A1
(43) Pub. Date: Aug. 16, 2018

(54) ANTI-ROTATIONAL SOCKET RETAINER TOOL

(71) Applicant: Peter MILLER, Flemington, NJ (US)

(72) Inventor: Peter MILLER, Flemington, NJ (US)

(21) Appl. No.: 15/883,210

(22) Filed: Jan. 30, 2018

Related U.S. Application Data
(60) Provisional application No. 62/458,694, filed on Feb. 14, 2017.

(51) Int. Cl. B25B 23/00; B25B 13/50

(52) U.S. Cl. CPC B25B 23/0085; B25B 13/50

(57) ABSTRACT

An anti-rotational socket retainer tool for retaining a socket over one of a pair of threaded fasteners (e.g., bolt/nut) in a fixed, non-rotatable position, illustratively, at adjacent hubs/flanges of pipe sections while another tool is used to rotatably attach/detach the other fastener end thereto. The anti-rotational socket retainer includes a central base having top and bottom surfaces, and integrally formed opposing support arms extending laterally from the base between the top and bottom surfaces to define a concave arcuate contact surface having a predetermined radius of curvature greater or equal to the curvature of the pipe section. The distal ends of the lateral arms define an arc not exceeding one-hundred and eighty degrees. A drive member extends from the top surface of the base and at a predetermined distance from the arcuate contact surface to retain a socket selected for placement over the fastener end to be held in position.

### CROSS REFERENCE TO RELATED APPLICATIONS

This patent application claims the benefit of U.S. Provisional Application No. 62/458,694, filed Feb. 14, 2017, the content of which is incorporated by reference herein in its entirety.

### BACKGROUND OF THE INVENTION

### 1. Field of the Invention

This invention relates to socket wrench kits and more particularly to device and method for retaining a socket in a stationary position while using a socket wrench kit or other tool to tighten or loosen a rotatable fastener such as a bolt and suit fastener.

### 2. Description of the Related Art

Joining sections of pipes or tubing end-to-end is performed in various industries and infrastructure including the automotive industry, energy pipelines, sewer systems, general plumbing and many other industries. In many instances, the opposing ends of the pipes or tubing include radially extending flanges which typically extend perpendicular to the longitudinal axis of the pipe section or fitting. The flanges usually include spaced-apart apertures for receiving a threaded bolt/nut fastener so that adjacent pipe section and fittings can be joined together end-to-end at their flanges in a well-known manner. The nut and bolt fasteners extending through the flange apertures are tightened and loosened using commercially available wrenches and power tools in a manner that is also well-known.

There are often situations in which there is limited accessibility to the threaded fasteners at the adjacent ends of the pipe sections due to the surrounding environment where the flanges of the pipe sections are located. For example, the engine compartment of most motor vehicles, such as trucks and cars, is typically crowded with many components which makes it cramped and difficult to work in when making a repair. The repair work often requires the removal of other components to provide sufficient access to replace a detective part. In addition, once accessible, it may still be difficult to provide a wrench or socket wrench to both ends of the fastener, i.e., the bolt head and nut, to either loosen or tighten the threaded fastener as required. Moreover, a bolt and nut can become rusted and fuse together so that both ends of the fastener rotate in the same rotational direction if a wrench or socket is not provided contemporaneously at both ends of the fastener to prevent one of the ends from rotating.

Therefore, an anti-rotational tool is needed that can be used in tight-quarters where appropriate tools cannot be manually applied to secure one end of the fastener against rotation, and locations which can prevent undesirable rotation of an end of a threaded bolt-nut fastener or other rotatable fastener. It would also be advantageous to provide an anti-rotational tool that can be used to retain fasteners at the adjacent ends of pipe sections or tubing to prevent undesirable rotation of one of the ends of the fastener. It would be further desirable to provide one or more anti-rotational tools configured to prevent rotation of fasteners used with different sized pipe sections and tubing. There is a need for an anti-rotational tool that can be easily attached to one end of the fastener to prevent its undesirable rotation. The deficiencies described above are overcome and other advantages are obtained by the embodiments of an anti-rotational socket retainer tool as described in detail below.

### SUMMARY OF THE INVENTION

The disadvantages heretofore associated with the prior art are overcome by the present invention of an anti-rotational socket retainer tool for retaining a socket over one of a pair of fasteners (e.g., a threaded bolt or nut) in a fixed, non-rotatable position, for example, when the fastener is used to fasten adjacent hubs/flanges of pipe sections. The anti-rotational socket retainer tool, when attached to an appropriate socket, will maintain one of the fasteners, e.g., the bolt in a fixed non-rotatable position, while a ratchet wrench or other tool is used to rotatably attach/detach the other fastener, e.g., the nut thereto the threaded bolt, or vice versa.

In an embodiment, an anti-rotational socket retainer comprises a central base portion having top and bottom surfaces, a pair of integrally formed opposing lateral support arms extending from the base between the top and bottom surfaces and defining a concave arcuate contact surface having a predetermined radius of curvature, the distal ends of the lateral arms defining an arc not exceeding one-hundred and eighty degrees (180°); and a male drive member extending from the top surface of the base and centrally disposed at a predetermined distance from the arcuate contact surface, the drive member configured to receive a socket. In one aspect, the lateral arms define an arc of from one-hundred and forty degrees (140°) to one-hundred and eighty degrees (180°). In another aspect, the inner contact surface of the lateral arms is textured. In still another aspect, the contact surface of the first and second distal ends of the lateral arms is textured.

In one aspect, at least a portion of the socket retainer is magnetized. In another aspect, the distal ends of the lateral support arms are magnetized. In yet another aspect, the male drive member includes a spring-loaded bearing configured to releasably retain the socket.

In one aspect, the radius of curvature of the contact surface is predetermined to correspond to the outside diameter of a circular pipe or tubing work piece. In another aspect, the socket retainer circumscribes a portion of the pipe or tubing and the predetermined radius of curvature of the contact surface is greater than the radius of the outer diameter of the pipe or tubing to define a spatial gap between at least one of the first and second distal ends of the pair of lateral support arms and the adjacent surface the pipe or tubing. In still another aspect, the bottom surface of the central base portion includes a recess configured and dimensioned to receive a male drive member of an extension bar.

In another embodiment is a method for tightening or loosening a removable nut and bolt fastener assembly passing through an opening in at least one flange integral with the end of a length of pipe or tubing using a socket wrench kit having an elongated handle, the method comprising the steps of: providing the anti-rotational socket retainer of claim 1; providing a first and a second socket configured to mate with the nut and the head end of the bolt; attaching the first socket to the male member of the socket retainer; positioning the first socket and attached socket retainer over one of the nut or the bolt end passing through the opening in the flange to thereby align the axis of the male drive member with the central axis of the fastener assembly and position the lateral arms of the socket retainer proximate to, or in contact with the outer surface of the pipe or tubing; attaching the second socket to the drive member of the socket wrench kit; positioning the second socket over the end of the fastener opposite the socket retainer; and rotating the handle of the socket wrench kit to rotate the second socket and associated fastener, wherein the opposite end of the fastener is held stationary by the anti-rotational socket retainer.

In one aspect, the step of positioning the first socket and the male drive member of the socket retainer on one of the nut or the bolt end comprises: inserting the male drive member of an extension bar into a mating recess formed in the bottom surface of the central base portion of the socket retainer; manually positioning the first socket and attached socket retainer over one end of the fastener assembly; and applying a force sufficient to engage the first socket with the end of the fastener assembly.

In another aspect, the socket retainer is held in position against the surface of the pipe or tubing by the secure engagement of the socket with the fastener assembly. In yet another aspect, the socket retainer is held in position against the outer surface of the pipe or tubing by the force of gravity. In still another aspect, the socket retainer is held in position against the outer surface of the pipe or tubing by magnetic force.

### BRIEF DESCRIPTION OF THE DRAWINGS

Preferred embodiments are described below with reference to the drawings in which:

FIG. 1 is a top, rear, right side perspective view of an anti-rotational socket retainer having a socket wrench tool attached and together being operably positioned in contact with the outer surface of a circular pipe section to illustratively secure two flanged pipe section ends together with a threaded fastener by retaining the nut of a threaded fastener assembly in a stationary position while the opposing bolt of the fastener is being rotated by a socket wrench kit;

FIG. 2 is a top, rear, right side perspective view of the anti-rotational socket retainer of FIG. 1 illustratively positioned about the outer surface of another circular pipe section and securing two pipe section ends together with a threaded fastener by illustrating retaining the bolt head of a threaded fastener in a stationary position while the opposing nut of the fastener is being rotated by the socket wrench kit;

FIG. 3 is a top view of the anti-rotational socket retainer of FIG. 1;

FIG. 4 is a top, front perspective view showing the inner contact surface of the anti-rotational socket retainer of FIG. 1;

FIG. 5 is a front elevation view of the anti-rotational socket retainer of FIG. 1; and

FIG. 6 is a bottom, rear, left side perspective view of the anti-rotational retainer of FIG. 1 provided with a recess configured and dimensioned to receive the male drive member of an extension bar.

In the following description of the invention, identical reference numerals have been used, when appropriate, to designate the same or similar elements that are common to the figures. Further, unless specifically stated otherwise, the features shown in the figures are not drawn to scale, but are shown for illustrative purposes only. For convenience, the anti-rotational socket retainer of the invention may be referred to as the “socket retainer”.

### DETAILED DESCRIPTION OF THE INVENTION

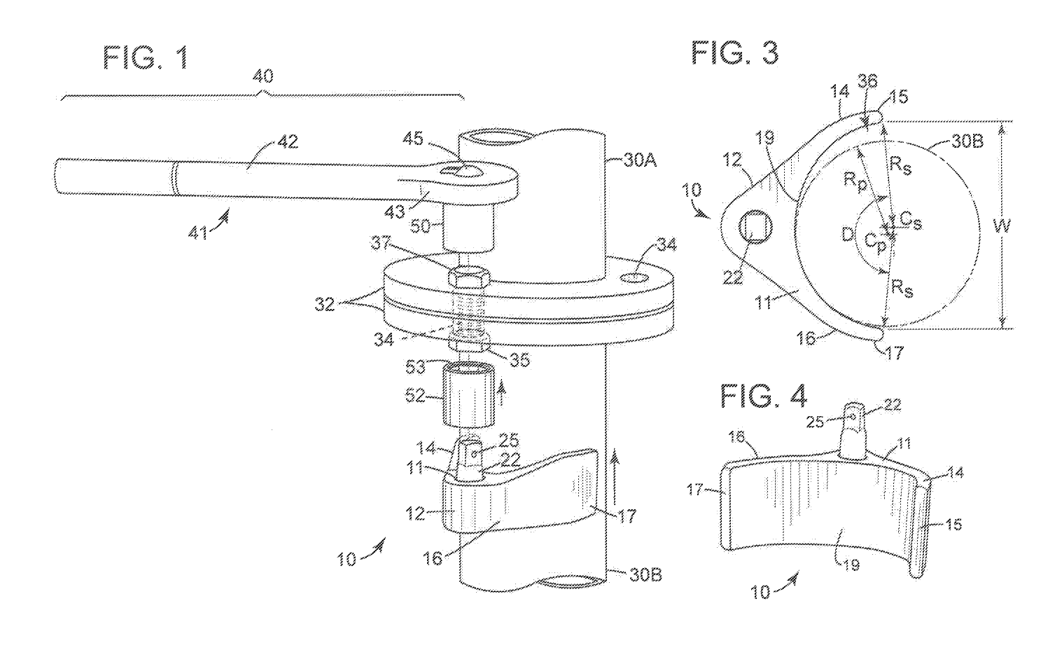

FIGS. 1-6 illustrate various embodiments for the use of the anti-rotational socket retainer 10 of the invention in conjunction with a conventional socket 52 of a socket wrench kit 40 to prevent the rotation of one of the components of a rotatable fastener assembly (e.g., the end of a threaded bolt fastener) while the other element (e.g., the nut) is being rotated onto or off of the threaded shaft of the bolt.

Referring now to FIG. 1, a socket wrench kit 40 is illustratively shown being used to tighten (or loosen) a fastener that is positioned to secure adjacent flanges 32 attached to the ends of two pipe sections 30A and 30B (collectively pipe sections 30). The socket wrench kit 40 can be any conventional commercially available socket wrench kit, such as a ¼, ½ or ¾ drive wrench kit. The socket wrench kit 40 is discussed herein for purposes of better understanding the invention and does not form a part of the invention. The socket wrench kit 40 generally includes a drive wrench or ratchet 41 which can be supplied with one or more sockets wrench tools (“socket”) 50. The ratchet 41 includes a handle 42 attached to a head portion 43 with a selectively rotatable drive shaft or post 44 and a ratchet reversing switch 45. The drive shaft 44 can include a spring-loaded ball bearing 25 to releasably secure a socket 50 to the drive shaft 44 in a well-known manner.

The sockets 50 are typically available as a set of sockets of varying prescribed sizes for engaging metric or Imperial (SAE) sized bolts and nuts as is well-known to those of ordinary skill in the art. Alternatively, the sockets 50 can be configured with Torx or Allen wrench fittings or Philips or slotted screw drivers, among other fastener engaging fittings which are commercially and/or are well-known in the art. Although the socket wrench kit 40 is generally described herein as including a ratcheting wrench 41, a person of ordinary skill in the art will appreciate that a non-ratcheting wrench with a handle having and elongated drive shaft extending therefrom or other well-known hand or power tool can alternatively be provided to receive and secure a socket 50 for engaging a rotatable fastener such as a threaded bolt and nut fastener assembly.

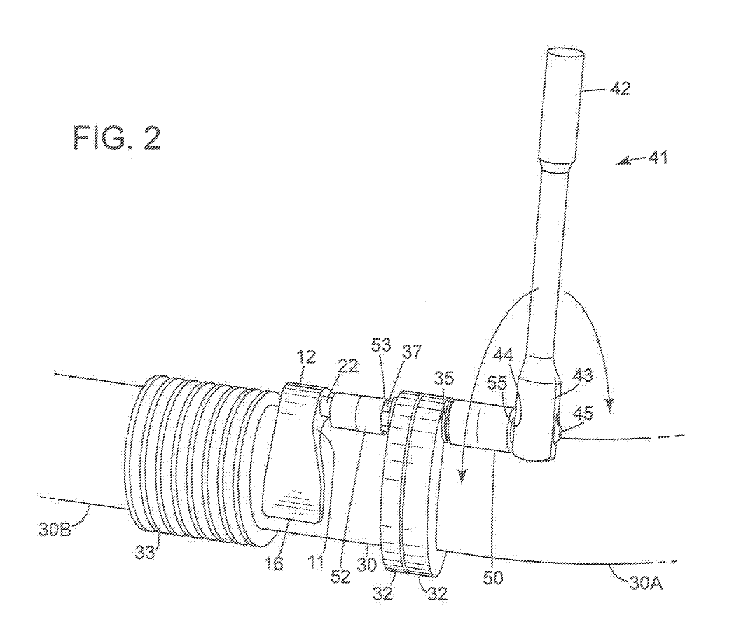

Referring now to FIG. 2, the pipe sections 30 can be fabricated from metal, such as steel, cast iron or any other metal, although the fabrication material of the pipe sections/flanges is not to be considered limiting. For example, a pipe section can be fabricated from aluminum or an aluminum alloy with a length or portion thereof being formed as flexible tubing 33 to facilitate installation and reduce vibration, e.g., in automotive installations. The pipe sections 30 can be of any sized having customary outer diameters (OD) sizes, commonly used in various applications, e.g., automotive, water and gas mains, industrial piping, and the like. The diameter and lengths of the pipe sections and tubing are not to be considered limiting. For example, the outer diameters of the pipe sections 30 can be metric-sized or any custom-sized pipe section. The pipe sections 30 can include a hub or flange 32 on one end for fastening to another pipe section or to any other structure. The pipe flanges 32 include one or more bores or apertures 34 sized to receive a fastener, such as a threaded bolt 35. The pipe sections 30 and flanges 32 are discussed herein for purposes of better understanding the applications and use of the invention and do not a form part of the invention.

Referring specifically to FIGS. 1 and 2, the anti-rotational socket retainer 10 of the present invention is configured to contact a surface of a portion of the circular-shaped pipe 30B adjacent the flanged end 32 that is to be joined, end-to-end to the flanged end of pipe 30A using a bolt 35 and mating nut 37. As best shown in FIGS. 3 and 4, the socket retainer 10 comprises a generally U-shaped central base portion 12 having a male drive member 22 projecting from an upper surface 11 and a pair of symmetrical opposing lateral support arms 14 and 16 terminating in distal ends 15, 17. The first and second lateral support arms 14, 16 are preferably integrally formed with the base portion 12 to form the generally U-shaped socket retainer 10, although such configuration is not to be considered limiting. The anti-rotational socket retainer is preferably fabricated from a metal or metal alloy material such as steel, and can be fabricated using a casting process, followed by computer-aided machining to form a monolithic structure. Alternatively, the retainer can be machined from a block or other portion of solid metal, such as a section of a flange having the desired diameter of the pipe that is to be joined. A person of ordinary skill in the art will appreciate that the fabrication materials and methods are not to be considered limiting.

The anti-rotational socket retainer 10 includes the top or upper surface 11 (FIG. 3), a bottom surface 13 (FIG. 6), an exterior (rear) surface 18 (FIGS. 1, 2 and 6) and an inner (front) surface 19 (FIGS. 3-5). The male drive member 22 extends perpendicularly from the top surface 11 and includes an end portion, e.g., the conventional square-shaped end (e.g., FIG. 4), which is configured for insertion into, for example, a corresponding square-shaped female recess 55 (FIG. 2) formed in the bottom end of the socket 50. The male drive member 22 commonly includes a spring-loaded ball bearing 25 (FIG. 4) to removably secure the socket 50 in secure mating relation for use.

Referring now to FIG. 6, the bottom surface 13 of the socket retainer 10 includes a recess 24, e.g., a square opening configured and dimensioned to receive the driving end 48 of an extension bar 46. The extension bar 46 includes an elongated shaft 47 of predetermined length, e.g., 3 inches, 6 inches, 8 inches, or longer, with one end formed as the driving end 48 and a mating opening 49 in the opposing end to receive the drive shaft 44 of the ratchet 41 or a driving end 48 of another extension bar. The extension bar 46 can be of any commercially available size and does not form a part of the invention. The driving end 48 also commonly includes a spring-loaded bearing 25 to secure a socket 52 to the driving end 48 in a well-known manner. The extension bar 46 can be used for manually positioning the anti-rotational socket retainer 10 in difficult-to-reach areas along a pipe section 30, as discussed in further detail below. Once the socket retainer 10 and attached socket 50 are in place on the fastener and in contact with the adjacent pipe, there is no need to manually support the socket retainer.

The central base 12, first and second lateral support arms 14, 16 collectively form the inner surface 19 of the socket retainer 10, which is arcuate in shape and configured to circumscribe a portion of the surface of a pipe section 30, as illustratively shown in FIGS. 1-3. More specifically, the inner surface 19 is defined as a concave arcuate contact surface having a predetermined radius of curvature, where the distal ends of the lateral support arms 14, 16 define an arc not exceeding 180°. In one embodiment, the radius of curvature of the inner surface 19 generally conforms to the radius of curvature of the outer surface of the circular pipe section 30 for which the socket retainer 10 is fabricated for use. For example, a pipe 30 having an outer diameter of two inches, i.e. a radius of curvature of one inch, the radius of the inner surface 19 would also be at least one inch. Similarly, a pipe having an outer diameter of twelve inches, i.e., a radius of six inches, the radius of the inner surface 19 would also be at least six inches.

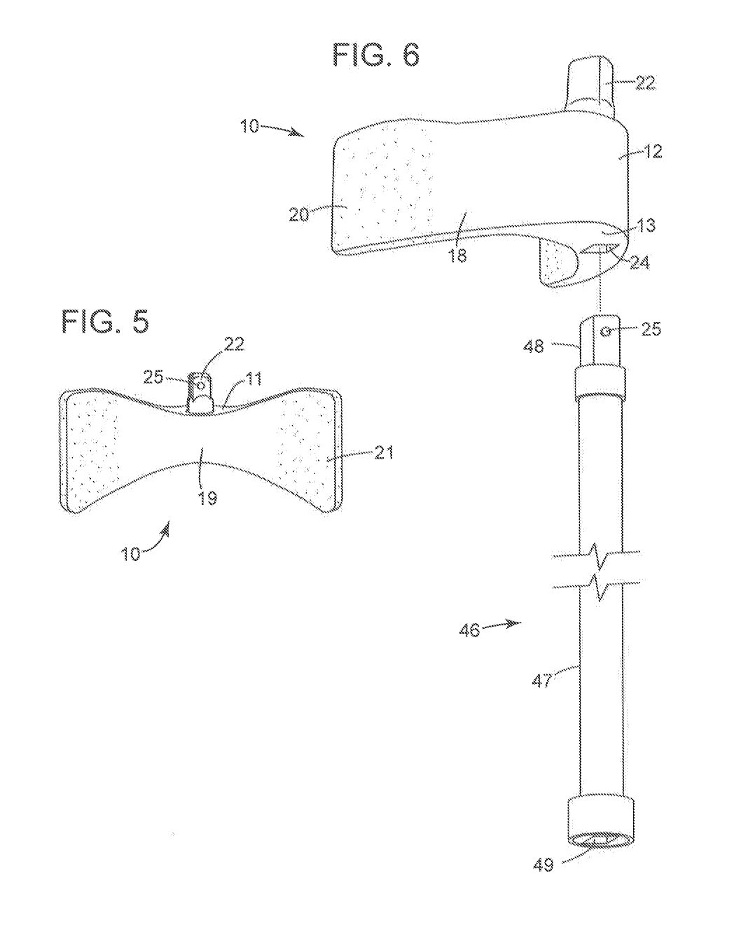

Referring now to FIG. 5, in one embodiment, at least a portion of the first and second lateral support arms 14, 16 include a textured or roughened surface area 21 to increase frictional forces with the outer surface of the pipe section 30. In one embodiment, the inner surface 19 is cast with a textured or grit-like surface. In another embodiment, a coating having a high coefficient of friction (e.g., Carbinite® or other well-known texturing materials) can be applied to the inner surface 19 to increase surface friction. In an alternative embodiment as illustratively shown in FIGS. 1 and 6, at least a portion 20 of the first and second lateral support arms 14, 16 are magnetized to better improve contact and secure the socket retainer 10 against the outer surface of the pipe section 30 for use in orientations where gravity cannot be relied upon to maintain the socket retainer in an operable position.

Referring now to FIG. 3, the radius of curvature of the inner surface 19 of the socket retainer 10 is preferably greater than the radius of the pipe section 30 with which the socket retainer 10 is being used. The center point “C_{P}” and corresponding radius of curvature “R_{P}” variables for the pipe section 30 and the center point “C_{S}” and corresponding radius of curvature “R_{S}” variables for the socket retainer 10 are illustratively shown. The center points C_{P} and C_{S} are shown at different locations (i.e., offset from each other) because the radius of curvature R_{P} of the pipe 30 is less than the length R_{S} of the socket retainer. A person of ordinary skill in the art will appreciate that the center points C_{P} and C_{S} will differ based on the radius of the respective pipe section 30 and socket retainer 10.

Referring again to FIG. 3, the distance “W” between the distal ends 15, 17 of the lateral arms 14, 16 of the socket retainer 10 is determined by the arc “D”. The arc D of the socket retainer 10 is illustratively shown as extending approximately 180 degrees, although such degrees of curvature are not considered limiting. For example, where the radius of curvature R_{S} is greater than radius of curvature R_{P}, the arc D of the symmetrically shaped socket retainer 10 can illustratively be in a range of 140 to 180 degrees so that a gap 36 will be formed between the outer surface of the pipe section 30 and an end of the first or second arms 14, 16. The gap 36 prevents the first and second lateral support arms 14, 16 from being locked into position against the outer surface of the pipe section 30 and enables a user to easily rotate and/or move the socket retainer 10 back and forth with respect to the outer surface of the pipe section 30 so as to be able to properly align and engage its attached socket 52 with an end of the fastener (e.g., bolt 35 or nut 37) positioned on or adjacent to the flange and pipe section 30. The length of the gap 36 can illustratively be approximately one-quarter inch (¼″) as between one of the distal ends 15, 17 of the lateral arms and the outer surface of the pipe, although such length of the gap is not considered limiting.

FIGS. 1 and 2 illustratively depict the use of the anti-rotational socket retainer 10 of the present invention with a socket wrench kit 40 to secure two adjacent pipe sections 30A and 30B together along their longitudinal axes by their respective flanges 32 using threaded bolt 35 and nut 37 type fasteners. In completing the assemble, a mechanic attaches a first socket 50 sized to engage the bead of bolt 35 (or nut 37) to the drive 44 of the ratchet tool 43, and the ratchet reversing switch 45 (e.g., push button or lever) is set to allow the wrench 41 and first socket 50 to lock and rotate together in a clockwise direction to tighten the fastener 35, 37 or in a counter-clockwise direction to loosen the fastener 35, 37 in a well-known manner. Similarly, a second socket 52 that is configured to engage the head of the corresponding nut 37 (or bolt 35) is attached to the male drive 22 on the top surface 11 of the socket retainer 10. The user determines which of the two ends of the fastener are to be rotated and held in a fixed position, based on the accessibility of the respective elements of the fastener. For example, the user may determine that the bolt 35 will be rotated and its corresponding nut 37 is to be held stationary, or vise-versa. By way of example only, FIG. 1 illustrates the bolt 35 to be rotated by the wrench kit 40, while the nut 37 is prevented from rotating by the socket retainer 10. Conversely, and by way of example only, FIG. 2 illustrates the nut 37 to be rotated by the wrench kit 40, while the bolt 35 is prevented from rotating by the socket retainer 10.

Referring now to FIG. 1, the user manually positions the anti-rotational socket retainer 10, with the socket 52 attached, about the pipe section 30B proximate the end of the fastener (e.g., nut 37) that is intended to be retained in position when loosening or tightening the other end of the fastener (e.g., bolt 35). The curved inner (front) surface 19 of the socket retainer 10 is positioned so that it contacts with the outer surface of the adjacent pipe section 30B. The distal end of the second socket 52 is axially aligned and positioned over the nut 37 in a well-known manner. The user can properly align the distal end of the socket 52 by slightly rotating the socket retainer 10 about its central axis, since the gap 36 provides additional space for maneuvering as between the outer surface of the pipe section 30B and the lateral support arms 14, 16, as described above with respect to FIG. 3. For limited access or hard-to-reach work areas, the user can insert the male end 48 of the extension bar 46 into the female drive adapter 24, and grasp the lower portion of the extension bar shaft 47 to help maneuver, align and engage the second socket 52 with the nut 37. Once the distal end of the second socket 52 properly engages the nut 37, the inner portion 19 of the socket retainer 10 is positioned to contact and be held in place against the adjacent outer surface of the pipe section 30B manually, magnetically or by the force of gravity, depending upon the orientation of the pipe flange. Where frictional forces between the distal end of the second socket 52 and the end of the fastener (e.g., nut) are sufficient, it may be possible to allow the socket retainer 10 to extend freely from the fastener about the pipe section 30B, or to be supported on the surface of the flange.

The user then positions the socket wrench kit 40 with the first socket 50 attached to engage the opposing end of the fastener, e.g., the bolt 35 for rotation in a direction to either tighten or loosen the fastener as required. In FIG. 1, when the wrench kit 40 is rotated, the bolt 35 will rotate in the same rotational direction due to the rotational forces exerted upon the bolt head by the first socket 50.

Referring now to FIG. 3, once the socket wrench kit 40 begins to rotate, the socket retainer may also rotate slightly if a gap 36 exists between the inner portion 19 of one of the lateral support arms 14, 16 and the outer surface of the pipe section 30B. For example, assume in FIG. 3 that the second socket 52 is attached to the male drive 22, the second socket 52 is engaging the nut 37, and the socket wrench kit 40 is positioned to rotate the opposing head of bolt 35 as shown in FIG. 1. If the threaded bolt 35 is rotated by the wrench kit 40 in a clockwise direction, then the rotational forces on the shaft of the bolt 35 would be transferred to the nut 37 to cause the second lateral support arm 16 to rotate and contact the outer surface of the pipe section 30B, while the gap 36 will loon between the first lateral support arm 14 and the opposing outer surface of the pipe section 30B, as illustratively shown in FIG. 3. Conversely, if the bolt 35 is rotated by the wrench kit 40 in a counter-clockwise direction, then the counter-clockwise rotational forces on the shaft of the bolt 35 will be transferred to the nut 37 and through the socket 52 to the retainer 10 to cause the lateral support arm 14 to move into contact with the outer surface of the pipe section 30B, while the gap 36 forms between the second lateral support arm 16 and the opposing outer surface of the pipe section 30B. Although there may be an initial small rotational movement by the socket retainer 10 to close the gap 36 when the initial rotational forces are applied, once the gap 36 is closed, the socket retainer 10. the second socket 52 and the engaged fastener (e.g., nut 37 or bolt 35) is prevented by the contact of the lateral support arm with the pipe from rotating any further. As such, the anti-rotational socket retainer 10 of the present invention serves to facilitate and hasten the secure placement and removal of a fastener, such as a threaded bolt/nut fastener, or any other well-known types of paired fasteners that require rotational forces to connect or disconnect such paired fasteners.

As will be appreciated by those familiar with the assembly of large diameter flanged pipes, such as water and sewer mains having a dozen or more nuts and bolts around the perimeter of the abutting flanges, the tightening of the bolts can require two workers because of the special arrangement and the effort required. However, by placement of the anti-rotational socket retainer of the present disclosure on the nut that has been preliminarily threaded onto the exposed end of the bolt and held in position on the pipe by gravitational and/or magnetic force, a single worker can rotate the bolt to secure the faces of the flanges in the desired contacting position.

While preferred embodiments of the present invention have been shown and described above and in the attached drawings, it will be obvious that such embodiments are provided by way of example only. Numerous variations, changes and substitutions will occur to those skilled in the art without departing from the invention herein. Accordingly, it is intended that the invention be limited only by the spirit and scope of the appended claims.

What is claimed is:

1. An anti-rotational socket retainer comprising:
a central base portion having top and bottom surfaces, a pair of integrally formed opposing lateral support arms extending from the base between the top and bottom surfaces and defining a concave arcuate contact surface having a predetermined radius of curvature, the distal ends of the lateral arms defining an arc not exceeding one-hundred and eighty degrees (180°); and
a male drive member extending from the top surface of the base and centrally disposed at a predetermined distance from the arcuate contact surface, the drive member configured to receive a socket.

2. The socket retainer of claim 1 in which the lateral arms define an arc of from one-hundred and forty degrees (140°) to one-hundred and eighty degrees (180°).

3. The socket retainer of claim 1 in which the inner contact surface of the lateral arms is textured.

4. The socket retainer according to claim 3 in which the contact surface of the first and second distal ends of the lateral arms is textured.

5. The socket retainer according to claim 1 that is at least in part magnetized.

6. The socket retainer according to claim 5 in which the distal ends of the lateral support arms are magnetized.

7. The socket retainer of claim 1, wherein the male drive member includes a spring-loaded bearing configured to releasably retain the socket.

8. The socket retainer of claim 1, wherein the radius of curvature of the contact surface is predetermined to correspond to the outside diameter of a circular pipe or tubing work piece.

14. The socket retainer of claim 8, wherein the socket retainer circumscribes a portion of the pipe or tubing and the predetermined radius of curvature of the contact surface is greater than the radius of the outer diameter of the pipe or tubing to define a spatial gap between at least one of the first and second distal ends of the pair of lateral support arms and the adjacent surface the pipe or tubing.

10. The socket retainer of claim 1 in which the bottom surface of the central base portion includes a recess configured and dimensioned to receive a male drive member of an extension bar.

11. A method for tightening or loosening a removable nut and bolt fastener assembly passing through an opening in at least one flange integral with the end of a length of pipe or tubing using a socket wrench kit having an elongated handle, the method comprising the steps of:
providing the anti-rotational socket retainer of claim 1;
providing a first and a second socket configured to mate with the nut and the head end of the bolt;
attaching the first socket to the male member of the socket retainer:
positioning the first socket and attached socket retainer over one of the nut or the bolt end passing through the opening in the flange to thereby align the axis of the male drive member with the central axis of the fastener assembly and position the lateral arms of the socket retainer proximate to, or in contact with the outer surface of the pipe or tubing;
attaching the second socket to the drive member of the socket wrench kit;
positioning the second socket over the end of the fastener opposite the socket retainer; and
rotating the handle of the socket wrench kit to rotate the second socket and associated fastener, wherein the opposite end of the fastener is held stationary by the anti-rotational socket retainer.

12. The method of claim 11, wherein the step of positioning the first socket and the male drive member of the socket retainer on one of the nut or the bolt end comprises:
inserting the male drive member of an extension bar into a mating recess formed in the bottom surface of the central base portion of the socket retainer;
manually positioning the first socket and attached socket retainer over one end of the fastener assembly; and
applying a force sufficient to engage the first socket with the end of the fastener assembly.

13. The method of claim 11, wherein the socket retainer is held in position against the surface of the pipe or tubing by the secure engagement of the socket with the fastener assembly.

14. The method of claim 11, wherein the socket retainer is held in position against the outer surface of the pipe or tubing by the force of gravity.

15. The method of claim 11, wherein the socket retainer is held in position against the outer surface of the pipe or tubing by magnetic force.
